(19) United States
(12) Patent Application Publication
(10) Pub. No.: US 2010/0005406 A1
(43) Pub. Date: Jan. 7, 2010

(54) METHOD OF PRESENTING INFORMATION

(75) Inventors: William M. Hathaway, Powell, OH (US); David M. Russo, Mission Viejo, CA (US)

Correspondence Address: MICHAEL BEST & FRIEDRICH LLP, 100 E WISCONSIN AVENUE, Suite 3300, MILWAUKEE, WI, 53202, US

(73) Assignee: MORESTEAM.COM LLC, Lewis Center, OH (US)

(21) Appl. No.: 12/166,905

(22) Filed: Jul. 2, 2008

(51) Int. Cl. G06F 3/048; G06F 17/30

(52) U.S. Cl. 715/764; 707/1; 707/E17.001

(57) ABSTRACT

A method of displaying visual information to a user of a video display. The method includes defining a dynamic portion of the visual display, providing a mask that obscures the dynamic portion of the visual display for an observable period of time, and providing a second display of content to the dynamic portion of the visual display during the observable period of time, the second display of content being occluded by the animated content during the observable period of time.

### BACKGROUND

There are multiple ways of providing visual information to individuals using a computer monitor or video screen. Example ways include providing electronic content in one or more machine-readable file formats that are processed using commonly available hardware and software applications into signals transmitted to a monitor or other type of video screen, which converts the signals into a visual display. It is well-known to provide content files to the computer either locally, e.g., by way of storage media associated with the user's computer, or remotely via communication with a web site.

### SUMMARY

Computer-generated animation provides a rich, dynamic user experience. Computer-generated animation entails the process of generating intermediate frames between two images to give the appearance that the first image evolves smoothly into the second image, thus creating the illusion of motion. Sophisticated animation software enables the programmer to identify specific objects in an image and define how they should move and change. The software may be used to render or adjust transitional frames or to automatically render transitional frames using interpolation of graphic parameters. There are many commercially available software applications that are popular for creating computer generated animations, including products licensed by Adobe Incorporated under the brand name “Flash”. Animating techniques using a computer tend to take time and skill to develop, both of which entail expense.

Using animation techniques, in combination with user-provided inputs, allows programmers to develop computer-based games, activities and simulations to provide an engaging environment for users. Computer-based games, activities and simulations can have instructional value and can be used to practice various skills. Such applications typically include various ways for the user to interact with the user's computer so as to provide user inputs, which in turn generate one or more responses from the computer-based game. In some formats, the game is played in a networked or distributed environment and uses high-powered processors and software for providing responses to the user inputs according the game's protocols. By combining animation and computing power, computer-based games, simulations, and like activities have become a popular vehicle for both entertainment and instruction. Consequently, users of games and web sites generally increasingly expect the smooth operation of displays provided by animation software and associated content. However, the expense of programming animations can be prohibitive, and often standard desk-top computers do not have the computing power for using the gaming software, i.e., specific gaming consoles with specially designed processors, graphics hardware and software are required. Also, when some animation applications are used to construct a web-page, the animation application can restrict the user's ability to provide inputs to the computer.

The invention provides, among other things, a method of providing a visual display of information combining animation and a graphical user interface to afford the ability to pass user inputs and other database variables between the user's computer and a database server. The method affords the ability to present changing displays of information communicated from the web server in response to user inputs, and provide smooth transitions between presentations by using animated content, e.g., creating an illusion of motion during transitions.

In one embodiment, the invention provides a method of presenting visual information to a user of a computer having a video display including providing html code to the computer, converting the html code into a first visual display, providing animation objects to the computer and converting the animation objects into a second visual display occluding at least a portion of the first visual display, providing a third visual display replacing the portion of the first visual display and removing the second display to reveal the third visual display.

In another embodiment, the invention provides a method of presenting visual information to a user of a computer having a video display, providing content to the computer including providing a database communicating with the computer and containing a plurality of content objects and animation objects, database management software for managing the database in response to user inputs, and web-page construction software for managing html web pages using the content objects and animation objects and defining at least a portion of the video display as a dynamic display portion converting at least one content object into a first visual display on the video display, receiving a user input, in response to the user input, making a call to the database, in response to the call, providing animation content to the computer using animation objects, converting the animated content into a second visual display occupying the dynamic display portion and occluding at least a portion of the first visual display for an observable period, in response to the call, providing a third visual display on the dynamic display portion of the video display replacing the first visual display including providing at least one content object from the database to the computer and converting the at least one content object into the third visual display during the observable period, and removing the second visual display to reveal the third visual display to the user.

In yet another embodiment, the invention provides a method of displaying visual information on a video display to a user including defining a static portion of the visual display and a dynamic portion of the visual display, providing a first display of content to the visual display including providing a database containing content objects and animation objects, database management software for managing the database in response to user inputs, and web-page construction software for managing html web pages using the content objects and animation objects, providing a mask obscuring the dynamic portion of the visual display, the mask including a display of animated content for an observable period of time, providing a second display of content to the dynamic portion of the visual display during the observable period of time, the second display of content being occluded by the animated content during the observable period of time.

In another embodiment, the invention provides a method of dynamically displaying visual information on a video display to a user including providing a first display of content to the video display, including providing a relational database containing a plurality of content objects and animation objects, database management software for making a query of the database in response to user inputs and providing a first subset of content and animation objects from the plurality of content and animation objects in response to the query, web-page construction software for managing html web pages using the first subset of content objects and animation objects, the web-page construction software providing a template defining a static portion of the video display and a dynamic portion of the visual display, and browser software for converting the first subset of content objects into a display on the video display, and animation software for converting the first subset of animation objects into an animated display on the video display, providing a second display of content to the dynamic portion of the visual display, the second display of content being provided in transition from the first visual display in response to a user input and including a second subset of content and animation objects provided from the plurality of content and animation objects in response to a query of the database, providing a mask for alternately revealing and obscuring the dynamic portion of the visual display in response to a user input, the mask including a third subset of content objects and animation objects affording observation of the dynamic portion of the visual display and a forth set of animation objects occupying the dynamic portion of the display for an observable period of time to occlude the dynamic portion of the display, the mask occluding the dynamic portion of the display in response to the user input and during transition between the first visual display and the second visual display.

Other features and advantages of the invention will become apparent to those skilled in the art upon review of the following detailed description, claims, and drawings.

### BRIEF DESCRIPTION OF THE DRAWINGS

FIG. 1 is a schematic diagram of a system adapted to practice a method of the invention.

FIG. 2 is a schematic diagram of a system adapted to practice a method of the invention.

FIG. 3 is an illustration of an exemplary webpage incorporating an embodiment of the invention.

FIG. 4 is an illustration of the exemplary webpage of FIG. 3 following a display transition.

FIGS. 5A to 5E are exemplary webpages illustrating sequences of display transitions incorporating an embodiment of the invention.

FIG. 6 is a flow chart of the operation of an embodiment of a method of the invention.

FIG. 7 is a timeline illustrating the timing of the operation of the method illustrated in FIG. 6.

FIG. 8 is a timeline illustrating the timing of the operation of another embodiment of a method of the invention.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “connected,” “coupled,” and “mounted” and variations thereof herein are used broadly and, unless otherwise stated, encompass both direct and indirect connections, couplings, and mountings.

As used herein the term “computer” is not limited to a device with a single processor, but may encompass multiple computers linked in a system, computers with multiple processors, special purpose devices, computers or special purpose devices with various peripherals and input and output devices, software acting as a computer or server, and combinations of the above. In general, computers accept and process information or data according to instructions (i.e., computer instructions).

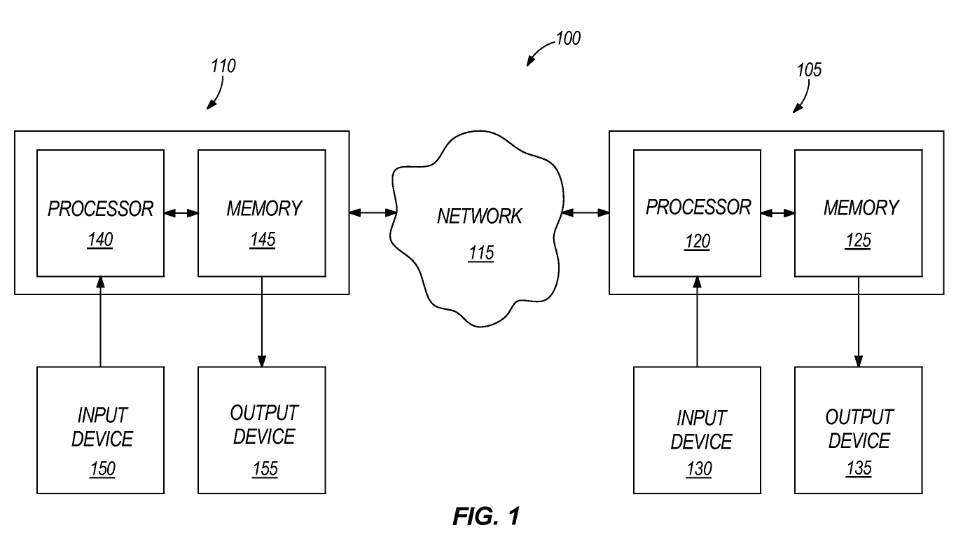

One exemplary system 100 for practicing the invention is schematically shown in FIG. 1. In general, the system 100 includes a first computer 105 (referred to below as the client computer, client, or local computer) in communication with a second computer 110 (referred to below as the server computer, server, or remote computer) over a network 115. As explained in greater detail below, the system 100 can be used to deliver content to a user of the system 100 (e.g., instructional content). As described below, the requirements of the system 100 are flexible.

In particular, while only one client 105 and only one server 110 are shown in FIG. 1, the system 100 can include multiple servers 110 and/or multiple clients, 105 the number of clients 105 being limited only by the capacity of the network 115 and the servers 110. The client 105 includes a processor 120, memory 125 (e.g., RAM, program storage, data storage, etc.), and one or more input/output devices 130 and 135 (e.g., disk drive, optical drive, display, printer, touch screen, keyboard, mouse etc.). Example types of client computers include, but are not limited to, an electronic device capable of accessing the Internet including the World Wide Web (e.g., an Internet appliance), a handheld device, a laptop computer, a desktop computer, etc. Those of ordinary skill in the art will recognize that the terms “processor,” “client computer,” “browser,” “network” and the like are broadly defined and can apply to a wide variety of devices. The client 105 typically includes an operating system adapted to support a graphical user interface (GUI) and adapted to run a browser. The browser may be a web browser such as Netscape Navigator, Microsoft Explorer, Mozilla Firefox or a program with similar functionality that may access information from the server 110. The client 105 receives input from the input device 130 (e.g., a keyboard, a mouse, a CD-ROM, etc.) and communicates outputs to output device 135 (e.g., a display, a printer, a read/write device, etc.). Of course, the input/output devices can include a device that communicates inputs and receives outputs (e.g., a touch screen, a read/write device, etc.) The client 105 also receives inputs and communicates outputs through one or more auxiliary ports, such as a USB (universal serial bus) port, a network interface, a wireless port, and/or embedded web interface.

The client 105 is connected to the network 115, which can be any local network (LAN) or wide-area network. The server 110 includes a processor 140, memory 145, one or more input/output devices 150 and 155, and one or more auxiliary ports. The server 110 includes a server interface, such as a common gateway interface (CGI) or Internet Server Application Programming Interface (ISAPI), and a web site. The web site includes a graphical user interface module, a knowledge base, HTML, XML, and/or other files, and associated components.

Files stored in the memory 125 or input devices 130 of the client computer 105 are said to be stored locally. Files stored in the memory 145 or input devices 150 of the server 110 are said to be stored remotely.

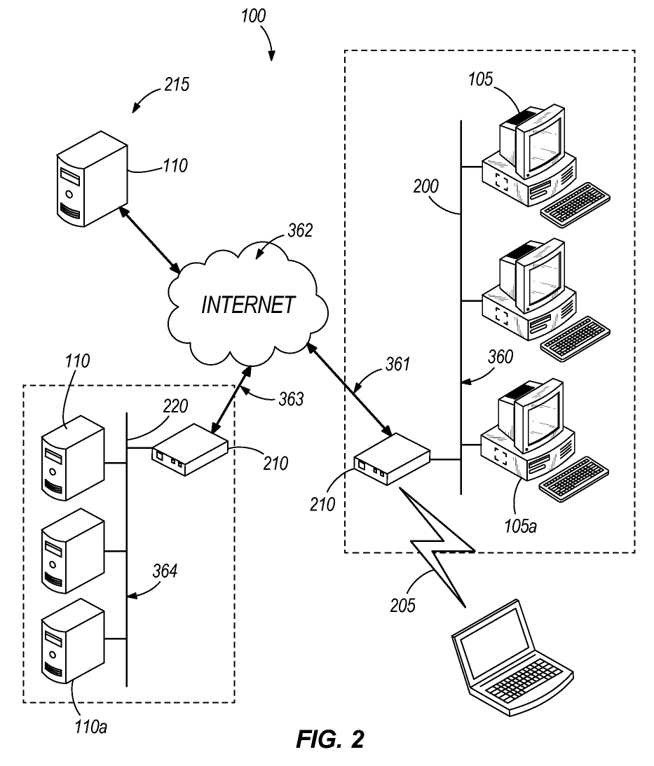

A second construction of the system 100 is shown in FIG. 2. A plurality of clients 105 reside on a LAN 200. Additional clients 105 can access the LAN 200 via a wireless interface 205. The LAN 200 includes a modem 210 for accessing the Internet. The LAN 200 can also include an intranet. The clients 105 access the Internet or intranet using Internet protocols. The clients 105 are adapted to communicate with the server 110 using Internet protocols such as IP/TCP (Internet Protocol/Transmission Control Protocol). The servers 110 can be standalone servers 215 or can reside on a LAN 220.

The operation of the invention will be described in connection with the system 100 illustrated by FIG. 1. There are, however, other systems capable of performing the invention (e.g., the system of FIG. 2). For example and as will be discussed below, not all of the components shown in FIG. 1 are required for some operations of the invention. In particular, the system 100 shown in FIG. 1 communicates content to the user of the system 100 via the network 115 and at least two computers 105 and 110. In other constructions, the content can be delivered to the user by other means. In still other constructions, the content can reside on the local computer operated by the user. For example, the content can be in the computer's local memory or on a media accessed locally by the client 105 rather than via the network 115. In some instances it is desirable to maintain the content on a server 110 to provide better security (e.g., to prevent copying and piracy).

In use of the system 100, the client 105 accesses the server 110 using a browser. The client 105 may communicate with the server 110 using known transmission standards. Once a connection is made with the server 110, the client 105 receives content from server 110. In one construction, the content includes a web page having text and links to other web pages or files (also collectively referred to as content objects). Example files include text files, executable files, audio files, video files, and audio/video files. The server 110 can also include animation objects, e.g., files that, when executed, display motion. Animation objects can be created using any suitable method (e.g., Adobe Flash, Shockwave, etc.). The server 110 includes a database comprising the content objects and the animation objects. As used herein, “display” of information of a content object is meant to include display of text files, execution of executable files, playing of audio and/or visual files, or any other method of presenting a content object to a user.

For one example, the client 105 can access a web site that, among other things, includes instructional content organized in one or more lessons. The lessons can be grouped in chapters, sections, and/or courses. Instructional content can be provided by a variety of means, including for example text files, executable files, audio files, video files, and audio/video files.

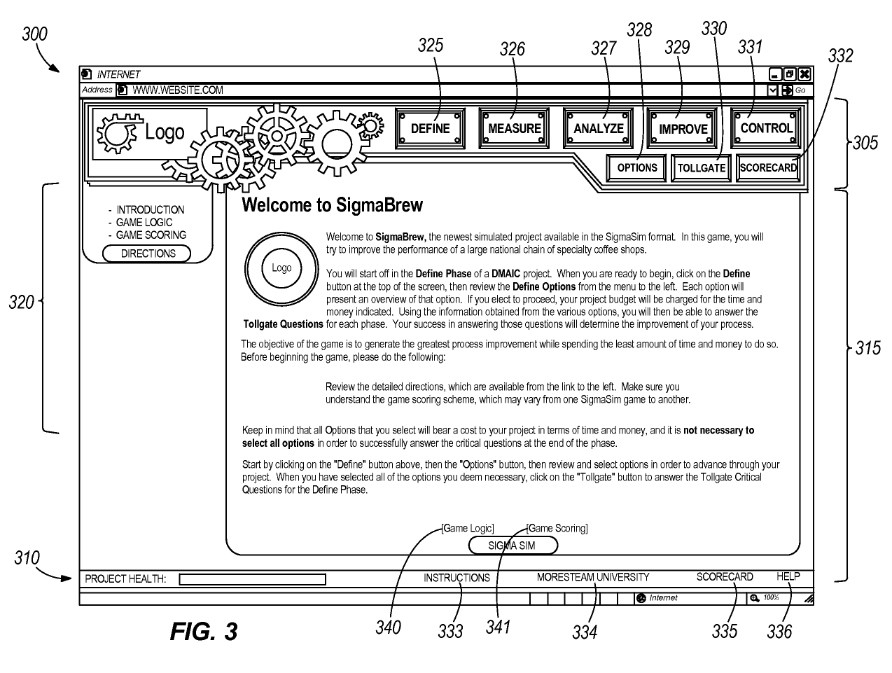

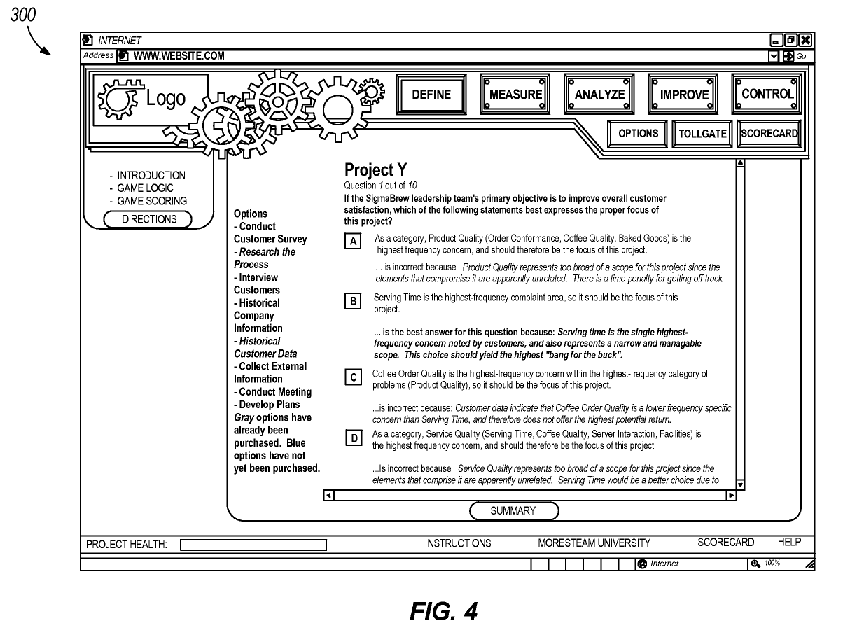

FIG. 3 is an exemplary webpage 300 incorporating an embodiment of the invention. The webpage 300 can be created using any standard method (e.g., HTML, Java, etc.) or combination of methods. Using a browser, a client 105 accesses the webpage 300 on a server 110. The server 110 containing the webpage 300, downloads the webpage 300 to the client 105. In the embodiment shown, the webpage 300 is constructed in four sections, a main navigation section 305, a secondary navigation section 310, a first content section 315, and a second content section 320. The sections can be populated/controlled individually and can be static or dynamic. That is, the webpage 300 can, in response to an input from a user, request information (a content object) from the server 110 for display in the first content section 315, leaving the remaining sections of the webpage 300 unchanged (see FIG. 4). Thus, the content sections are dynamic (changing) and the navigation sections are static (unchanging).

The webpage 300 can include several buttons 325-336 and hyperlinks 340-341 for accessing content objects. Clicking on one of the buttons 325-336 or hyperlinks 340-341 creates a user input, which causes the client 105 to take action such as retrieving a new content object from the server 110 and/or executing an animation object.

Display of a new content object can be subject to propagation delays, e.g., it may take several seconds (or longer) from the time a user makes a selection on the webpage 300 until the client 105 receives the new content object from the server 110 and displays the information in the content object. When a user makes a selection on a webpage by positioning a cursor over a button or hyperlink and clicking a mouse button, it is common practice for the cursor to change to a different shape (e.g., from an arrow to an hourglass) to indicate that the selection was recognized, and the new content object is being requested. The length of the delay from clicking a button, until new information is displayed, is dictated by several elements including the size of the content object (e.g., a video object may be relatively large and take a relatively long time to load where a text object may be relatively small and take a relatively short time to load), the performance (e.g., speed) of the client 105, the performance of the server 110, the number of devices accessing the server 110, and the speed of communication between the client 105 and the server 10. Referring back to FIG. 2, a client 105a requesting a content object from server 110a encounters at least five communication legs 360-364 in each direction (sending and receiving). Each communication leg adds a delay to the communication. The length of the delays are impacted by the bandwidth of each leg (e.g., relatively low bandwidth for a dial-up modem versus relatively high bandwidth for an ISDN modem) and the amount of that bandwidth being used by other devices.

It is desirable to provide a user with a consistent transition of information displays (e.g., when providing educational content) regardless of any delays. In addition, users occasionally miss the change of shape of the cursor and click more often than necessary, sometimes creating undesirable results. It is therefore also desirable to provide a more significant indication that the input has been recognized and is being operated on.

It is also desirable to use a database to provide content objects and animation objects to construct the web pages. Utilizing a database structure to store, organize and provide objects for components of a web-page affords a relatively speedy page load, and affords construction of a wide variety of web pages using the various combinations of components rather then having to author individual web-pages for the various combinations of components. Presenting a wide variety of web-page configurations is important in the context of providing an entertaining, game-like experience that varies based on user inputs, i.e., the selection of one or more variables presented to the user. Also, using a database structure in combination with a web-page construction affords game play without having to utilize the more expensive hardware/software of game consoles that tend to have a single use, i.e., gaming.

In order to enhance the game-like atmosphere, it is also desirable to use animation objects. However, it is cost prohibitive to create animation objects for each of the possible web page configurations that may be needed for a game design, i.e., for each combination of content components that could be used to create a web-page. Also, even if animation is used for each combination of web-pages, common animation software is not effective for receiving user inputs, i.e., offering variables to the user to choose from, and receiving user inputs for selecting variables.

In one aspect of the invention, a combination of a database structure is used to provide a wide variety of web page components, variables presented to the user, and mechanisms to receive user inputs indicating selection of the variables, and animations used for transitions during the intervals between selections of the variables. This combination affords use of animations to provide the game-like, entertaining atmosphere (meaning, moving images and sound displaying a wide variety of options for user input and corresponding results) at a low production cost and using standard equipment,

In one aspect of the invention, one or more animation objects are downloaded or transmitted to the client 105 from the server 110 when the client 105 accesses the webpage 300 on the server 110. One or more of the animation objects are executed when a user makes an input selection (e.g., by clicking on a button or hyperlink) at the client 105. The executed animation object displays an animation sequence on the display at the client 105. The animation covers (e.g., masks or occludes) the data that is to be changed by the new content object, during the time period the client 105 is waiting to receive the new content object and display the information in the content object. When the client 105 receives the content object, the client 105 displays the data from the content object in the background, i.e., behind the executing animation object, such that the data does not appear until the animation object finishes executing. The animation object is configured to run for a period of time that is greater than the longest projected time to request, receive, and display a new content object. Therefore, a user sees a consistent transition from one display to a second display including information from the new content object, regardless of the size of the content object or any delays encountered sending and receiving the content object. In some embodiments, it is desirable to have animation objects be as short as possible to transition between displays as quickly as possible; however, the animation objects should not be so short that they finish executing prior to the new data being displayed. The animation sequence provides an element of entertainment or a game-like atmosphere to the viewer at the client 105.

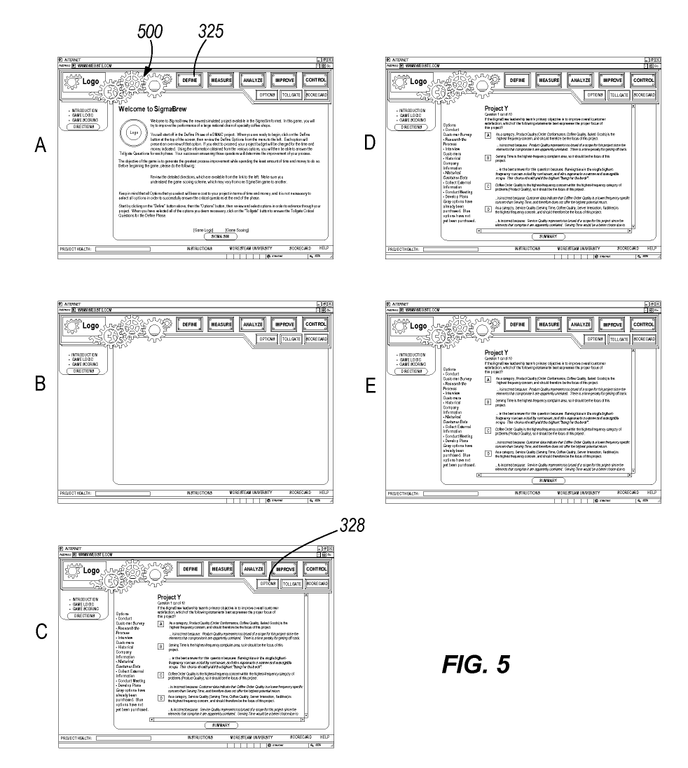

FIGS. 5A-5E illustrate sequences for obtaining and displaying two new content objects. FIG. 5A shows the webpage 300 accessed from a server 110 and displayed on a client 105. In the embodiment shown, the webpage 300 includes the four sections described above: the main navigation section 305, the secondary navigation section 310, the first content section 315, and the second content section 320. The sections 305, 310, 315, 320 can be populated/controlled individually. For example, the webpage 300 can, in response to an input from a user, request information (a content object) from the server 110 for display in the first content section 315. The remaining sections of the webpage 300 are unchanged (see FIG. 5C). When a user clicks, via a mouse or touchscreen (or other input mechanism), a “define” button 325 in the main navigation section 305, an animation object represented by the blank section 315 in FIG. 5B is executed. The animation object covers the data in the first content section 315. In one embodiment, the animation appears as a “curtain” being pulled down over the data. At the end of the execution of the animation object, the “curtain” is pulled up revealing the new data behind the animation object (see FIG. 5C). Additional animation objects can execute simultaneously. For example, a plurality of gears 500 in the main navigation section 305 can rotate to illustrate movement or animation. Other embodiments can use any suitable transition animation. Selecting an “option” button 328, causes a second animation object to execute, covering the secondary content section 320 of the webpage 300 (see FIG. 5D). After the second animation object finishes executing, information from a new content object is revealed in the secondary content section 320 (see FIG. 5E). In some embodiments, a transparent mask of the animation object covers the information from the content object. A user interacts with the content object by clicking through the transparent mask.

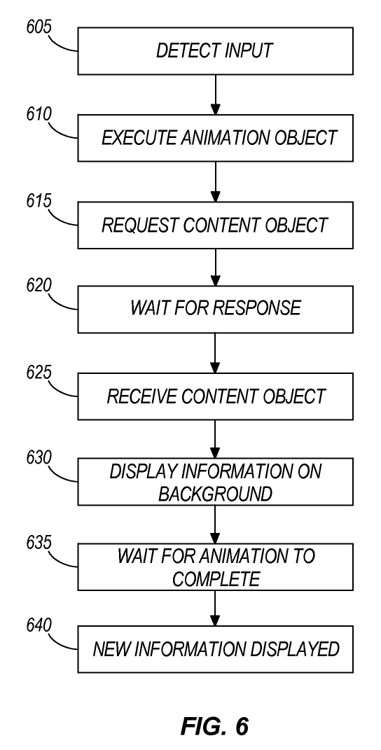

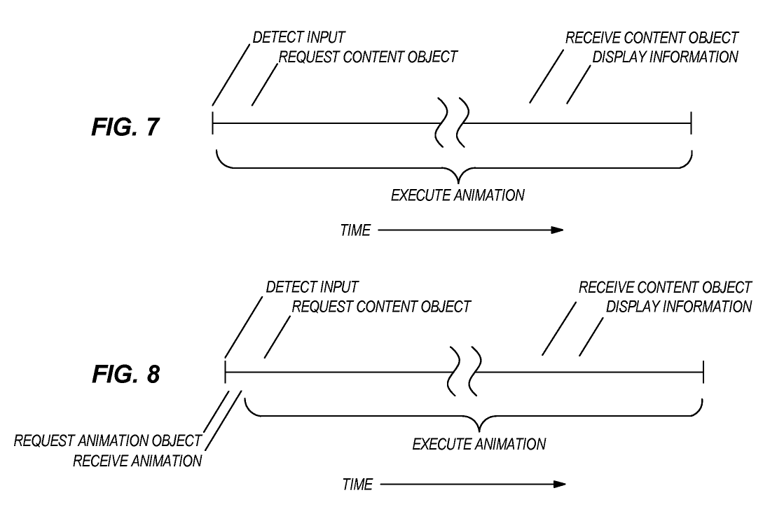

FIG. 6 is a flow chart of an embodiment of a method of the invention. FIG. 7 is a timeline illustrating the relative timing of the events in FIG. 6. When a user selects a button or hyperlink on a webpage, the client computer 105 detects this input (step 605) and executes an animation object (step 610). The client computer 105 determines which animation object to execute based on which button/hyperlink was selected. As described above, the animation object at least partially occludes the section of the webpage in which displayed information is to be changed. After initiating the execution of the animation object, the client 105 requests a new content object from the server 110 (step 615) and waits for a response to be received back from the server 110 (step 620). The amount of time until the response is received is variable, depending on propagation delays and the size of the content object. The timeline of FIG. 7 represents this variable delay using a gap in the middle of the timeline.

Following the delay, the client 105 receives the content object (step 625) and displays the information from the content object in the background (e.g., occluded behind the executing animation object) (step 630). The animation object is programmed to run for a set period of time that is longer than an expected delay for receiving the content object and displaying the content object's information. In some embodiments, a single animation object is used for each section of the webpage. In other embodiments, multiple animation objects are used. The client computer 105 can determine which animation object(s) to execute based on one or more factors (e.g., size of the requested content object, projected communication delays). Ideally, following receipt of the content object and display of its information, there should be a period of time where the animation object continues to execute (step 635). When the animation object finishes executing, the occlusion is removed and the information from the content object is displayed (step 640).

In another embodiment of the invention, shown in the timeline of FIG. 8, instead of server 110 providing the animation objects when the webpage 300 is initially loaded, the animation objects are retrieved from the server 110 every time a new content object is requested. Therefore, the additional steps of requesting the animation object, waiting, and receiving the animation object are inserted prior to executing the animation object. In some embodiments, the requests for the content object and the animation object can be sent at the same time (e.g., in a single communication packet). In these embodiments, the animation objects need to be relatively small to reduce the delays encountered by the client 105 in obtaining the animation object, such that the animation object executes as quickly as possible.

In some embodiments, animation objects have a transparent mask over a portion or all of one or more content objects. The transparent mask provides a user the ability to see and interact with the content object (e.g., click on an element of a content object) through the transparent mask. In some embodiments, the animation object is firewall “friendly” (e.g., not likely to be blocked by most firewalls), and the animation object is executed in response to a plurality of different inputs from a user, resulting in reduced development cost and effort.

Various other features and advantages of the invention are set forth in the following claims.

What is claimed is:

1. A method of presenting information, the method comprising:
requesting a webpage from a server;
receiving the webpage including a content object;
receiving an animation object from the server;
storing the animation object locally;
displaying the webpage including the content object;
detecting an input;
requesting a new content object from the webpage based on the input;
executing the animation object based on the input; and
displaying the webpage including the new content object.

2. The method of claim 1, further comprising dividing the webpage into a plurality of sections.

3. The method of claim 2, wherein at least one of the plurality of sections is static.

4. The method of claim 2, wherein at least one of the plurality of sections is dynamic.

5. The method of claim 4, wherein the content object is displayed in a dynamic section.

6. The method of claim 5, wherein the animation object masks the dynamic section while executing such that a user cannot see the new content object being displayed until the animation object finishes executing.

7. The method of claim 1, further comprising a transparent mask over the content object, a user interacting with the content object through the transparent mask.

8. A method of providing educational content to a user, the method comprising:
providing a webpage to a client, the webpage segmented into a plurality of sections including a first section and a second section;
providing an animation object with the webpage, the animation object configured to occlude the first section of the webpage for a period of time;
receiving a request for a content object from the client;
retrieving the content object from a database;
providing the content object to the client; and
executing the animation object prior to retrieving the content object.

9. The method of claim 8, wherein the content object is displayed in the first section.

10. The method of claim 8, further comprising providing a plurality of animation objects to the client including a first animation object and a second animation object.

11. The method of claim 10, further comprising receiving a second request for a second content object from the client, retrieving the second content object from the database, providing the second content object to the client, the second content object to be displayed in the second section, executing the second animation object and occluding the second section prior to retrieving the second content object.

12. A method of transitioning a display from a first image to a second image, the method comprising:
defining a first navigation section of the display;
defining a first content section of the display;
retrieving a first content object from a server;
displaying a plurality of navigation inputs in the first navigation section of the display;
displaying information from the first content object in the first content section of the display;
receiving an indication that a navigation input has been selected;
executing a first animation object, the first animation object occluding the first content section;
retrieving a second content object related to the navigation input selected from the server; and
displaying information related to the second content object in the first content section.

13. The method of claim 12, further comprising retrieving the first animation object with the first content object.

14. The method of claim 13, further comprising storing the first animation object locally.

15. The method of claim 12, further comprising storing the first animation object remotely.

16. The method of claim 12, wherein the information from the second content object is initially displayed in the background such that the second content object is not visible to a user until the first animation object finishes executing.

17. The method of claim 12, further comprising defining a second navigation section.

18. The method of claim 17, further comprising defining a second content section.

19. The method of claim 18, further comprising executing the first animation object when the second content object resides in the first content section and executing a second animation object when the second content object resides in the second content section.

20. The method of claim 19, wherein the first navigation section and the second navigation section are static and the first content section and the second content section are dynamic.

21. The method of claim 12, further comprising using a browser to present the first image and the second image.
